(19) United States
(12) Patent Application Publication
(10) Pub. No.: US 2026/0186230 A1
(43) Pub. Date: Jul. 2, 2026

(54) LENS ASSEMBLY, AND LENS MODULE

(71) Applicant: Luxshare Intelligent Manufacture Technology (Changshu) Co., Ltd., Changshu City (CN)

(72) Inventors: SinHong Lin, Changshu City (CN); ChiYing Lee, Changshu City (CN); HaoYun Lee, Changshu City (CN); JenCheng Sung, Changshu City (CN); WenYen Huang, Changshu City (CN)

(73) Assignee: Luxshare Intelligent Manufacture Technology (Changshu) Co., Ltd., Changshu City (CN)

(21) Appl. No.: 19/426,258

(22) Filed: Dec. 19, 2025

(30) Foreign Application Priority Data
Dec. 30, 2024 (CN) 202411999431.3

(51) Int. Cl. G02B 7/02

(52) U.S. Cl. CPC G02B 7/021

(57) ABSTRACT

A lens assembly and a lens module are disclosed. An elastic part and a lens are disposed on a lens mounting base. A first connection area of the elastic part and a second connection area of the elastic part are spaced apart to form a hollowed-out area. Meanwhile, a stopping part may restrict the movement distance of the lens within the lens module. The stopping part extends out from a hollowed-out area, allowing the stopping part to avoid the elastic part. By disposing a first reinforcement layer between the stopping part and the edge of a layout surface, the mechanical strength at the edge position of a main body is specifically improved. The first reinforcement layer is disposed opposite to the hollowed-out area to avoid the elastic part, preventing collision between the first reinforcement layer and the elastic part.

### CLAIM OF PRIORITY AND CROSS-REFERENCE TO RELATED APPLICATION

This application claims the benefit of Chinese Patent Application No. 202411999431.3, filed on Dec. 30, 2024, which is incorporated herein by reference in its entirety.

### BACKGROUND OF THE INVENTION

### 1. Field of the Invention

The present invention relates to the field of camera technology, and particularly to a lens assembly and a lens module.

### 2. Description of the Related Art

A lens mounting base is used to fix a lens and drive the lens to move. The lens mounting base can cooperate with a limiting structure inside a lens module to restrict the movement range of the lens. During the contact between the lens mounting base and the limiting structure, the limiting structure exerts an impact force on the lens mounting base, causing deformation or damage to the lens mounting base. However, directly increasing the overall thickness of the lens mounting base to improve its structural strength may occupy too much internal space of the lens module, and the movement of the lens mounting base may interfere with internal components. How to improve the structural strength of the lens mounting base without affecting its normal movement has become a problem to be solved.

### BRIEF DESCRIPTION OF THE INVENTION

In view of this, an embodiment of the present disclosure provides a lens assembly and a lens module.

In the first aspect, the present disclosure provides a lens assembly. The lens assembly comprises a lens, an elastic part, and a lens mounting base; the elastic part comprises a first connection area and a second connection area, the first connection area and the second connection area being spaced apart to form a hollowed-out area; the lens mounting base comprises a main body, a stopping part, and a reinforcement part, the lens being disposed on the main body, the main body comprising a layout surface perpendicular to an axial direction of the lens, the reinforcement part comprising a first reinforcement layer, the stopping part and the first reinforcement layer protruding from the layout surface, and a portion of the stopping part extending out from the hollowed-out area, the first connection area being fixedly connected to the main body; wherein the first reinforcement layer extends from the stopping part towards an edge of the layout surface, and a projection of the first reinforcement layer on the elastic part is located inside the hollowed-out area.

In the second aspect, the present disclosure further provides a lens module, comprising: a housing and the lens assembly according to the aforementioned first aspect; the housing haves a mounting cavity, the mounting cavity has a limiting surface; the lens assembly moves towards the limiting surface until the stopping part abuts against the limiting surface, and the elastic part elastically deforms and generates a reset elastic force.

### BRIEF DESCRIPTION OF THE DRAWINGS

FIG. 1 is a schematic structural view of one side of a lens assembly according to an embodiment of the present disclosure;

FIG. 2 is a schematic structural view of another side of the lens assembly according to an embodiment of the present disclosure;

FIG. 3 is an exploded view of the lens assembly according to an embodiment of the present disclosure;

FIG. 4 is a schematic structural view of one side of a lens mounting base according to an embodiment of the present disclosure;

FIG. 5 is a schematic structural view of another side of the lens mounting base according to an embodiment of the present disclosure;

FIG. 6 is a schematic structural view of an elastic part in some implementation manners according to an embodiment of the present disclosure;

FIG. 7 is a schematic structural view of the elastic part in other implementation manners according to an embodiment of the present disclosure;

FIG. 8 is a schematic diagram showing the positional relationship between the lens mounting base and the elastic part according to an embodiment of the present disclosure;

FIG. 9 is a partial schematic view of a main body according to a first embodiment of the present disclosure;

FIG. 10 is a partial schematic view of the main body according to a second embodiment of the present disclosure;

FIG. 11 is a cross-sectional view taken along line A-A in FIG. 7;

FIG. 12 is a partial schematic view of the main body according to a third embodiment of the present disclosure;

FIG. 13 is a cross-sectional view of a reinforcement part at line B-B in FIG. 12 in some implementation manners;

FIG. 14 is a cross-sectional view of the reinforcement part at line B-B in FIG. 12 in other implementation manners;

FIG. 15 is a partial schematic view of the main body according to a fourth embodiment of the present disclosure;

FIG. 16 is a partial schematic view of the main body according to a fifth embodiment of the present disclosure;

FIG. 17 is a partial schematic view of the main body according to a sixth embodiment of the present disclosure;

FIG. 18 is a partial schematic view of the main body according to a seventh embodiment of the present disclosure;

FIG. 19 is a partial schematic view of the main body according to an eighth embodiment of the present disclosure;

FIG. 20 is a schematic structural view of a housing according to an embodiment of the present disclosure;

FIG. 21 is a stress simulation diagram of the lens mounting base according to an embodiment of the present disclosure.

### DETAILED DESCRIPTION OF EMBODIMENTS OF THE INVENTION

Several preferred embodiments of the present disclosure will be described in detail in conjunction with the accompanying drawings as follows, however, the present disclosure is intended to encompass any substitutions, modifications, equivalents, etc., made thereto without departing from the spirit and scope of the present disclosure. In order to provide those skilled in the art with thorough understanding of the present disclosure, particular details will be described below in the preferred embodiments of the present disclosure, although those skilled in the art can understand the present disclosure without the description of these details.

In addition, it should be understood by those skilled in the art that the accompanying drawings are provided herein for purposes of illustration and that the accompanying drawings are not necessarily to scale.

Unless the context clearly requires otherwise, the terms “include,” “comprise,” and similar terms throughout the specification should be interpreted as meaning “including but not limited to,” that is, they have an inclusive meaning rather than an exhaustive one.

In the description of the present application, it should be understood that the terms “first,” “second,” and so on are used for descriptive purposes only and should not be construed as indicating or implying relative importance. Furthermore, in the description of the present application, unless otherwise specified, the term “multiple” means two or more.

Unless otherwise specified and limited, the terms “mounted,” “connected,” “fixed,” and similar terms should be broadly understood, for example, they may be fixed connections or detachable connections, or integrated; they may be mechanical connections or electrical connections; they may be directly connected or indirectly connected through intermediate media, and can be an internal connection or interaction relationship between two elements, unless otherwise specified. To those skilled in the art, the specific meaning of the above terms in this disclosure may be understood on a case-by-case basis.

For ease of illustration, spatially relative terms such as “inside,” “outside,” “below,” “underneath,” “lower part,” “upper part,” “above,” etc., are used herein to describe the relationship between one component or feature and another component or feature in the drawings. It will be understood that spatially relative terms may encompass different orientations of the device during use or operation other than those depicted in the figures. For example, if the device in the figures is flipped, the component described as being “below” or “underneath” another component or feature will then be positioned as being “above” that other component or feature. Thus, the example term “below” may encompass both above and below orientations. The device may be oriented in other ways (rotated 90 degrees or in other orientations), and the spatially relative descriptive words used herein should be interpreted accordingly.

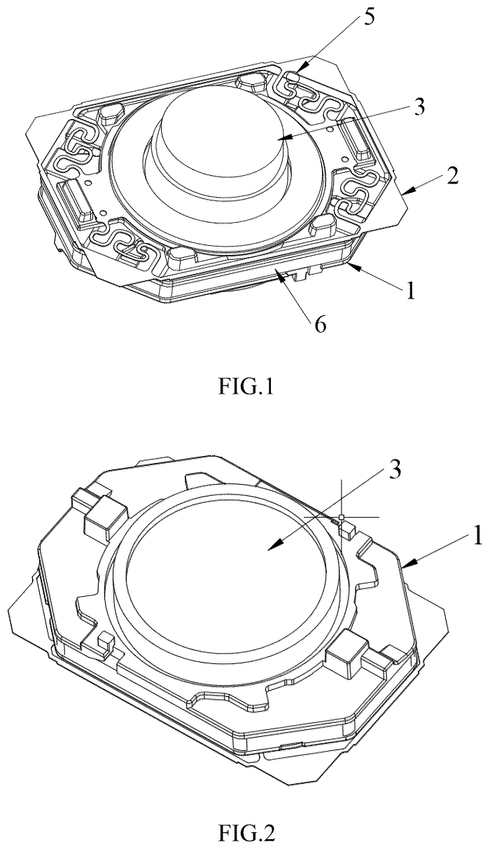

FIG. 1 and FIG. 2 are schematic structural views of the lens assembly of the present embodiment.

In some implementations, as shown in FIGS. 1-2, the lens assembly of the present embodiment includes a lens mounting base 1, and an elastic part 2, a lens 3, and a drive coil 6 disposed on the lens mounting base 1. The lens assembly of the present embodiment may be disposed within a lens module, and the drive coil 6 is used to drive the lens mounting base 1 to move along the axial direction of the lens 3.

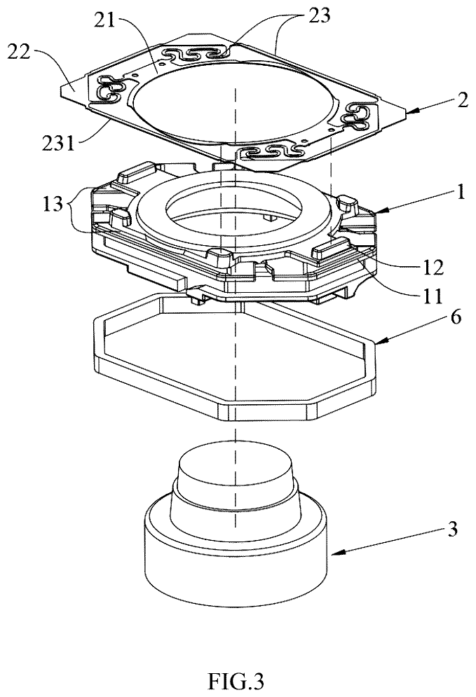

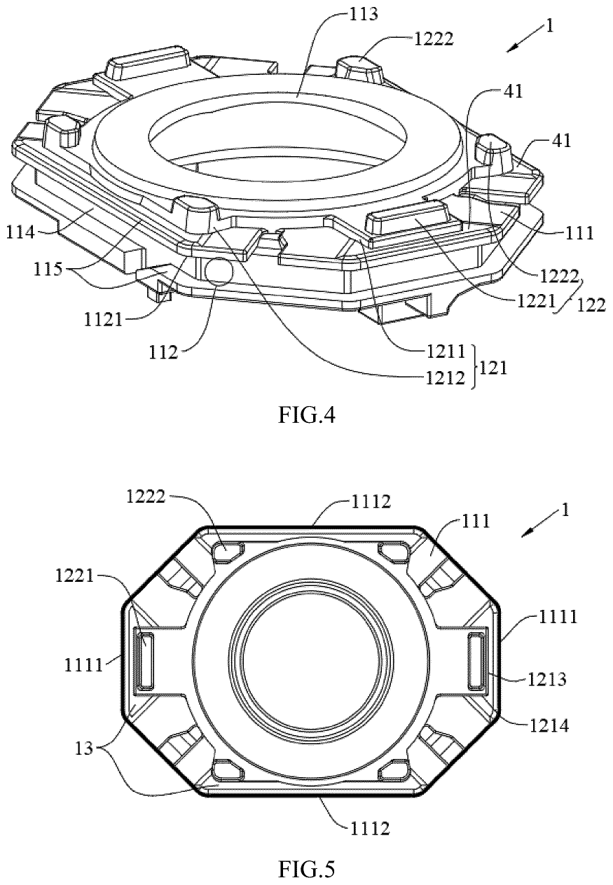

FIG. 3 is an exploded view of the lens assembly of the present embodiment. FIGS. 4 and 5 are schematic structural views of the lens mounting base 1 of the present embodiment.

In some implementations, as shown in FIGS. 3-5, the lens mounting base 1 of the present embodiment includes a main body 11, a stopping part 12, and a reinforcement part 13. The main body 11 is used for mounting the lens 3. The driving by the main body 11 enables the lens 3 to move along the optical axis and thus adjust the focal length. The main body 11 is provided with a layout surface 111 perpendicular to the axial direction of the lens 3. The reinforcement part 13 includes a first reinforcement layer 41.

Specifically, the main body 11 of the present embodiment is provided with a mounting hole 113, and the lens 3 is fixed in the mounting hole 113. The layout surface 111 faces the same direction as the lens 3.

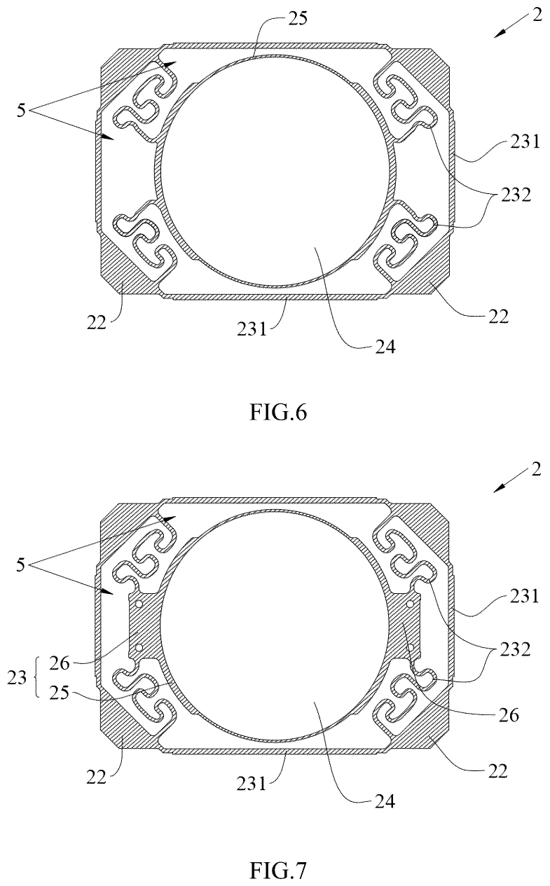

FIGS. 6 and 7 are schematic structural views of the elastic part 2 of the present embodiment. The area where the elastic part 2 is located in the figures is shown with cross-hatching (the hollowed-out area 5 has no cross-hatching).

In some implementations, as shown in FIGS. 6 and 7, the elastic part 2 includes a first connection area 21 and a second connection area 22. The elastic part 2 has a hollowed-out area 5. This hollowed-out area 5 reduces the weight of the elastic part 2 and increases the deformation amount of the elastic part 2.

Optionally, the elastic part 2 is configured as a sheet-like structure. The elastic part 2 further includes an elastic connection body 23. The elastic connection body 23 is connected between the first connection area 21 and the second connection area 22, or the elastic connection body 23 is connected between two second connection areas 22. The first connection area 21 is used for connection with the lens mounting base 1, and the second connection area 22 is used for connection with an inner area of the lens module, so that the lens assembly can be suspended inside the lens module.

Further referring to FIGS. 1 and 4, the stopping part 12 and the first reinforcement layer 41 protrude from the layout surface 111, and a portion of the stopping part 12 extends out from the hollowed-out area 5. The first connection area 21 is fixedly connected to the main body 11. Thus, the lens mounting base 1 can be suspended inside the lens module via the elastic part 2. When the drive coil 6 drives the lens mounting base 1 to move, it enables the elastic part 2 to generate a reset elastic force to drive the lens mounting base 1 to reset promptly. The reinforcement part 13 is used to improve the structural strength between the main body 11 and the stopping part 12, preventing the main body 11 from deforming during multiple collisions between the stopping part 12 and the limiting surface 72 inside the housing 7. The first reinforcement layer 41 is configured to extend on the layout surface 111. The thickness of the first reinforcement layer 41 may be configured to be 0.01 mm to 0.05 mm. Those skilled in the art can select an appropriate thickness (e.g., 0.02 mm) based on the material of the lens mounting base 1 and the impact force provided by the drive coil 6.

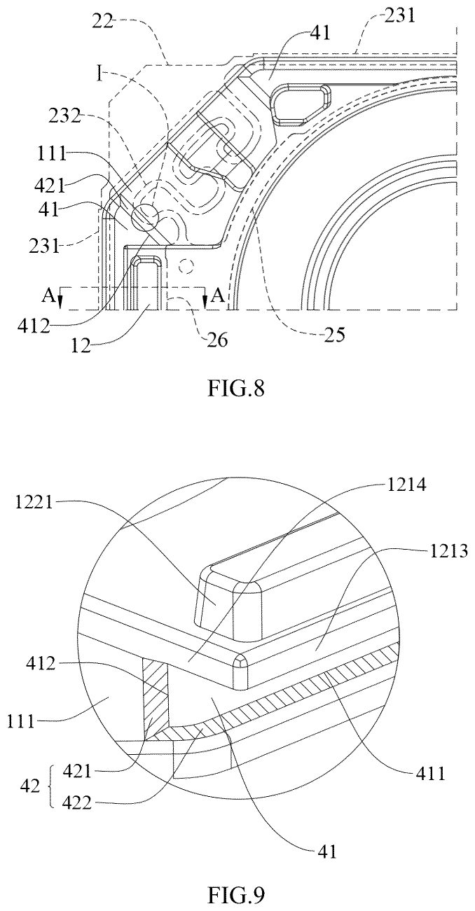

FIG. 8 is a schematic diagram showing the positional relationship between the lens mounting base 1 and the elastic part 2 according to the present embodiment. The outline of the elastic part 2 and the leader lines corresponding to the reference numerals of the elastic part 2 are shown with dashed lines.

Further referring to FIGS. 6-8, the first reinforcement layer 41 extends from the stopping part 12 towards the edge of the layout surface 111. Simultaneously, in a direction perpendicular to the layout surface 111, the first reinforcement layer 41 is located inside the hollowed-out area 5, that is, the first reinforcement layer 41 is disposed opposite to the hollowed-out area 5. The first reinforcement layer 41 of the present embodiment improves the structural strength of the lens mounting base 1, and the area of the first reinforcement layer 41 is limited to avoid contact between the first reinforcement layer 41 and the elastic part 2 during the upward movement of the lens mounting base 1. When the stopping part 12 abuts against the limiting surface 72, a gap still exists between the layout surface 111 and the elastic part 2.

In summary, in the lens assembly of the present embodiment, the elastic part 2 and the lens 3 are disposed on the lens mounting base 1. The first connection area 21 of the elastic part 2 is used for fixed connection with the lens mounting base 1, and the second connection area 22 is used for fixed connection with the inner area of the lens module, so as to suspend the lens mounting base 1 within the lens module. Meanwhile, the stopping part 12 may also be used to restrict the movement distance of the lens 3 within the lens module. Thus, the stopping part 12 is configured to extend out from the hollowed-out area 5, allowing the stopping part 12 to avoid the elastic part 2. Simultaneously, by disposing the first reinforcement layer 41 between the stopping part 12 and the edge of the layout surface 111, the mechanical strength at the edge position of the main body 11 is specifically improved, avoiding damage to the lens mounting base 1 after prolonged use of the lens assembly and preventing the edge position of the main body 11 from warping upward from the layout surface 111. On the other hand, during the upward movement of the lens mounting base 1, the elastic part 2 may undergo bending deformation. For this purpose, the first reinforcement layer 41 is configured to be disposed opposite to the hollowed-out area 5, so that the first reinforcement layer 41 can avoid the elastic part 2, preventing collision between the first reinforcement layer 41 and the elastic part 2.

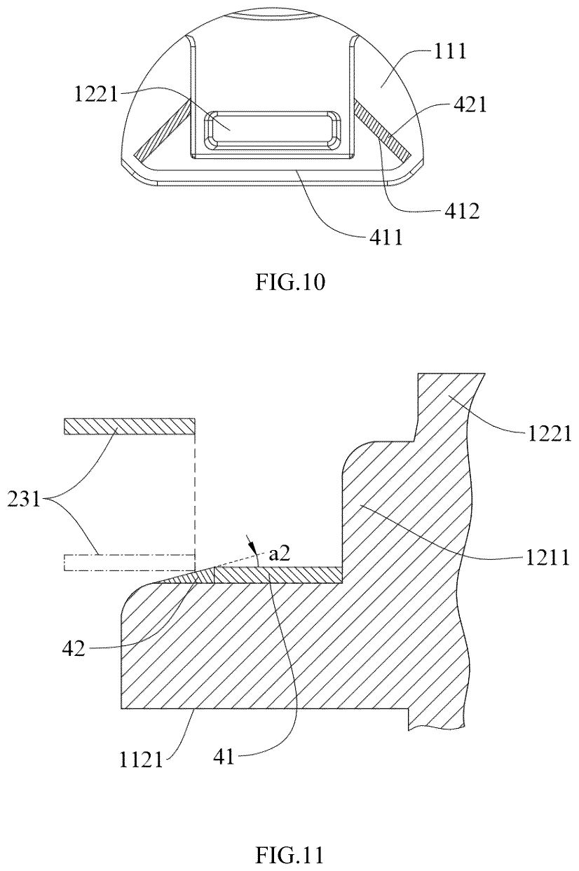

FIG. 9 is a partial schematic view of the main body 11 according to a first embodiment of the present disclosure. The area where the second reinforcement layer 42 is located in the figure is shown with cross-hatching.

In some implementations, as shown in FIGS. 4 and 9, the stopping part 12 includes a fixed protrusion 121 and a stopping body 122. The fixed protrusion 121 protrudes from the layout surface 111. The first connection area 21 is fixedly connected to the top surface of the fixed protrusion 121, that is, the first connection area 21 is mounted on the top of the fixed protrusion 121. Further referring to FIG. 8, the stopping body 122 protrudes from the top surface of the fixed protrusion 121 and is staggered from the first connection area 21. The stopping body 122 is configured to pass through the hollowed-out area 5. The protrusion height of the reinforcement part 13 is less than or equal to the protrusion height of the fixed protrusion 121, and the first reinforcement layer 41 is connected to the side wall of the fixed protrusion 121. Optionally, the top surface of the first reinforcement layer 41 is configured as a plane parallel to the layout surface 111.

The fixed protrusion 121 of the present embodiment increases the distance between the elastic part 2 and the layout surface 111, providing sufficient deformation space for the elastic connection body 23 during the movement of the lens mounting base 1. Simultaneously, stress concentration may occur at the connection position between the fixed protrusion 121 and the layout surface 111. For this reason, providing the first reinforcement layer 41 between the fixed protrusion 121 and the layout surface 111 can improve the structural strength between the fixed protrusion 121 and the layout surface 111.

FIG. 10 is a partial schematic view of the main body 11 according to a second embodiment of the present disclosure.

In some implementations, as shown in FIGS. 6-7, the elastic part 2 of the present embodiment further includes an elastic connection body 23. The elastic connection body 23 includes a plurality of first elastic arms 231. The second connection area 22 is provided in plurality and extends laterally from the lens mounting base 1. Two adjacent second connection areas 22 are connected by a first elastic arm 231, and at least a portion of the hollowed-out area 5 is formed between the first elastic arm 231 and the first connection area 21. A portion of the first elastic arm 231 is disposed opposite to the edge position of the main body 11.

Further referring to FIGS. 8 and 10, the stopping body 122 includes a plurality of first stopping bodies 1221. The plurality of first stopping bodies 1221 correspond to at least a portion of the first elastic arms 231. The first reinforcement layer 41 has a first side edge 411. The first side edge 411 is located on a side of the first reinforcement layer 41 away from the fixed protrusion 121. At least a portion of the first side edge 411 is parallel to and spaced apart from a corresponding first elastic arm 231.

In the present embodiment, when the lens mounting base 1 is close to the first elastic arm 231, in the extending direction of the layout surface 111, the first side edge 411 and the first elastic arm 231 have a predetermined distance. Thereby, contact between the first reinforcement layer 41 and the first elastic arm 231 is avoided.

In some implementations, as shown in FIG. 5, the layout surface 111 is a polygonal plane. The polygonal plane has a plurality of first sides 1111. The fixed protrusion 121 includes a plurality of first fixed blocks 1211. The plurality of first fixed blocks 1211 correspond to the plurality of first sides 1111. Further referring to FIG. 9, the first fixed block 1211 has a first connection surface 1213 and two second connection surfaces 1214 facing two sides of the first connection surface 1213. The first connection surface 1213 is parallel to a corresponding first side 1111. Further referring to FIG. 10, the first reinforcement layer 41 further has two second side edges 412 corresponding to the two second connection surfaces 1214. The second side edges 412 extend straight from the second connection surfaces 1214 towards the edge of the polygonal plane. The ends of the two second side edges 412 away from the first fixed block 1211 are spaced apart from each other and are connected to the two ends of the first side edge 411.

In the present embodiment, the ends of the two second side edges 412 connected to the first side edge 411 are splayed open, and the two ends of the two second side edges 412 are symmetrical with respect to the first fixed block 1211. Thus, under the premise of the limited layout surface 111 for the first reinforcement layer 41, the mechanical strength between the first fixed block 1211 and the main body 11 is increased as much as possible. Optionally, the length of the first reinforcement layer 41 can be configured as 1.35 mm.

In some implementations, as shown in FIGS. 1-4, the lens assembly further includes a drive coil 6. The main body 11 has a coil groove 112. The coil groove 112 faces a lateral side of the lens mounting base 1. The inner wall of the coil groove 112 has a second side surface 1121. The second side surface 1121 faces opposite to the layout surface 111 and corresponds to at least a portion of the reinforcement part 13.

FIG. 11 is a cross-sectional view taken along line A-A in FIG. 7. The positional relationship between the first elastic arm 231, shown by a dash-dot line in the figure, and the second reinforcement layer 42 corresponds to the position when the stopping part 12 abuts against a limiting structure within the lens module.

In some implementations, as shown in FIGS. 9 and 10, the reinforcement part 13 further includes a second reinforcement layer 42 protruding from the layout surface 111. The second reinforcement layer 42 includes a first extension segment 421. One side of the first extension segment 421 is connected to the second side edge 412, and the other side thereof connects to the layout surface 111 at an incline.

In this embodiment, the first extension segment 421 may increase the volume of the reinforcement part 13. Meanwhile, the first extension segment 421 may be configured to be opposite to a portion of the second elastic arm 232 (as shown in region I of FIG. 7). Thereby, the inclined first extension segment 421 is utilized to avoid the second elastic arm 232, preventing the second elastic arm 232 from contacting the first extension segment 421.

Furthermore, as shown in FIGS. 6-7, the elastic connection body 23 further comprises a plurality of second elastic arms 232 corresponding to the plurality of second connection areas 22. One end of each second elastic arm 232 is connected to a corresponding second connection area 22, and the other end is connected to the first connection area 21. The second elastic arms 232 are disposed in the hollowed-out area 5, and a portion of the second elastic arms 232 is opposite to a portion of the first extension segment 421.

In some implementations, as shown in FIG. 9, the second reinforcement layer 42 includes a second extension segment 422. The second extension segment 422 corresponds to the first elastic arm 231. One side of the second extension segment 422 is connected to the first side edge 411, and the other side thereof connects to the layout surface 111 at an incline, so as to avoid the first elastic arm 231. Optionally, the inclination angle of the second reinforcement layer 42 is 10° (as indicated by angle a2 in FIG. 11). Thereby, the inclined second extension segment 422 is utilized to avoid the first elastic arm 231, preventing the first elastic arm 231 from contacting the first extension segment 421 when the elastic part 2 deforms (as shown in FIG. 11).

In some implementations, as shown in FIGS. 4 and 6, the main body 11 has a mounting hole 113, and the lens 3 is disposed in the mounting hole 113. The first connection area 21 includes an annular body 25. An inner edge of the annular body 25 forms an avoidance hole 24 corresponding to the mounting hole 113, and the lens 3 extends through the avoidance hole 24. The annular body 25 in this embodiment may increase the contact area between the elastic part 2 and the lens mounting base 1, enabling the lens mounting base 1 to move along the axial direction of the lens 3 when driven to reset by the elastic part 2.

In some implementations, as shown in FIG. 6, the second elastic arm 232 extends curvilinearly and an end thereof is connected to the outer edge of the annular body 25.

Optionally, the ends of the plurality of second elastic arms 232 connected to the annular body 25 are uniformly distributed along the circumference of the annular body 25. Thereby, the configuration of the first connection area 21 is simplified, while the consistency of the reset driving force acting on the lens mounting base 1 in various directions is ensured.

In some implementations, as shown in FIG. 7, the first connection area 21 further includes a connection piece 26. The connection piece 26 extends out from the outer edge of the annular body 25, and the plurality of second elastic arms 232 extend curvilinearly and ends thereof are connected to the connection piece 26. Therefore, the connection piece 26 may further increase the contact area between the first connection area 21 and the lens mounting base 1. Moreover, a single connection piece 26 may simultaneously connect to multiple second elastic arms 232.

Optionally, the number of connection pieces 26 is two, and they are arranged symmetrically about the center of the annular body 25. The numbers of first elastic arms 231, second elastic arms 232, and second connection areas 22 are all four. Each single connection piece 26 is simultaneously connected to two second elastic arms 232.

Furthermore, as shown in FIG. 4, the main body 11 comprises a center body 114 and two flanges 115. The two flanges 115 extend laterally from the center body 114 relative to the mounting hole 113. The two flanges 115 and the side surface of the center body 114 form the aforementioned coil groove 112. Two sides of one flange 115 are respectively used to form the second side surface 1121 and at least a portion of the layout surface 111. The drive coil 6 in this embodiment is wound around the main body 11 via the coil groove 112. The lens module is also provided with a magnet. After being energized, the drive coil 6 generates an induced magnetic field, which interacts with the magnetic force generated by the magnet, thereby driving the main body 11 to move upward. During this process, the driving force from the drive coil 6 acts on the upper flange 115, causing this flange 115 to tend to warp. To address this, the two second side edges 412 in this embodiment can increase the layout surface 111 of the first reinforcement layer 41 on the flange 115, thereby enhancing the mechanical strength of the flange 115. Meanwhile, as shown in FIG. 8, the second side edges 412 may also provide more deformation space for the second elastic arms 232.

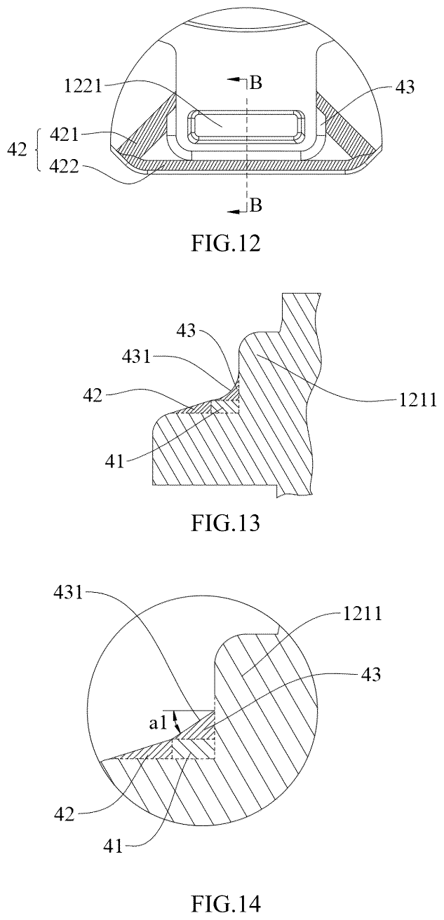

FIG. 12 is a partial schematic view of the main body according to a third embodiment of the present disclosure. In some implementations, as shown in FIG. 12, the reinforcement part 13 further comprises a third reinforcement layer 43. At least a portion of the third reinforcement layer 43 is disposed on top of the first reinforcement layer 41 and extends along the side wall of the fixed protrusion 121. The third reinforcement layer 43 in this embodiment increases the thickness of the reinforcement part 13, thereby further enhancing the mechanical strength between the main body 11 and the fixed protrusion 121. Furthermore, the third reinforcement layer 43 corresponds to the hollowed-out area 5, thus avoiding interference with the elastic part 2.

In some implementations, as shown in FIG. 12, the reinforcement part 13 further includes a third reinforcement layer 43. At least a portion of the third reinforcement layer 43 is disposed on top of the first reinforcement layer 41 and extends along the side wall of the fixed protrusion 121. The third reinforcement layer 43 in this embodiment increases the thickness of the reinforcement part 13, thereby further enhancing the mechanical strength between the main body 11 and the fixed protrusion 121. Furthermore, the third reinforcement layer 43 is disposed opposite to the hollowed-out area 5, thus avoiding interference with the elastic part 2.

FIG. 13 is a cross-sectional view of the reinforcement part 13 at line B-B in FIG. 12 in some implementation manners. FIG. 14 is a cross-sectional view of the reinforcement part 13 at line B-B in FIG. 12 in other implementation manners.

In some implementations, as shown in FIGS. 13 and 14, the third reinforcement layer 43 has a first side surface 431. One side of the first side surface 431 is connected to the fixed protrusion 121, and the other side thereof is connected to the top of the first reinforcement layer 41. The first side surface 431 is an arc surface or a flat surface.

Referring further to FIG. 13, the cross-sectional shape of the arc surface in its extending direction is a circular arc, and the radius of the circular arc is 0.06 mm to 0.12 mm.

Optionally, the radius of the circular arc may be 0.06 mm, 0.08 mm, 0.10 mm, or 0.12 mm. Configuring the first side surface 431 as a rounded form may optimize the manufacturing process of the lens mounting base 1 and improve product quality.

Referring further to FIG. 14, a side of the flat surface connected to the first reinforcement layer 41 is inclined toward the layout surface 111, and the inclination angle is 10° to 25° (as indicated by angle a1 in FIG. 14).

Optionally, the inclination angle of the flat surface may be 10°, 15°, 20°, or 25°. The inclination extent of this first side surface 431 may be selected based on the magnitude of the impact force and the height of the fixed protrusion 121.

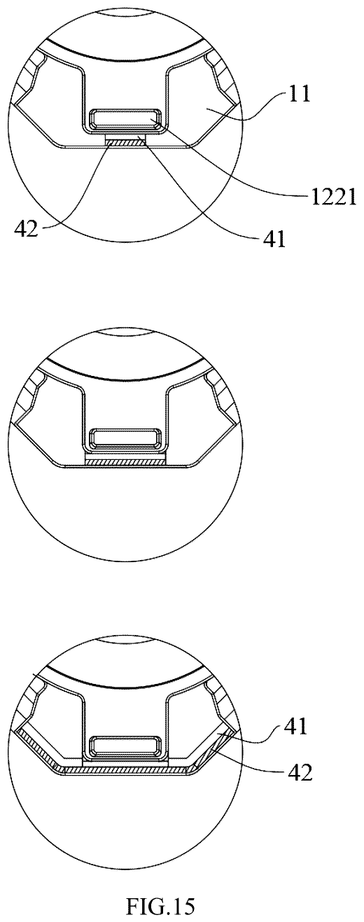

FIG. 15 is a partial schematic view of the main body 11 according to a fourth embodiment of the present disclosure.

In some implementations, as shown in FIG. 15, the lengths of the first reinforcement layer 41 and the second reinforcement layer 42, used for reinforcing the connection between the first fixed block 1211 and the main body 11, may be selected based on the magnitude of the impact force generated by the drive coil 6. For example, the first reinforcement layer 41 may be disposed between two second stopping bodies 1222 with a length configured as 0.45 mm. As another example, the length of the first reinforcement layer 41 may be configured to be consistent with the length of the first fixed block 1211, which may be 0.9 mm. As a further example, two ends of the first reinforcement layer 41 may be disposed on two sides of the second fixed block 1212 and extend along the edge of the layout surface 111, and this length may be 2.7 mm.

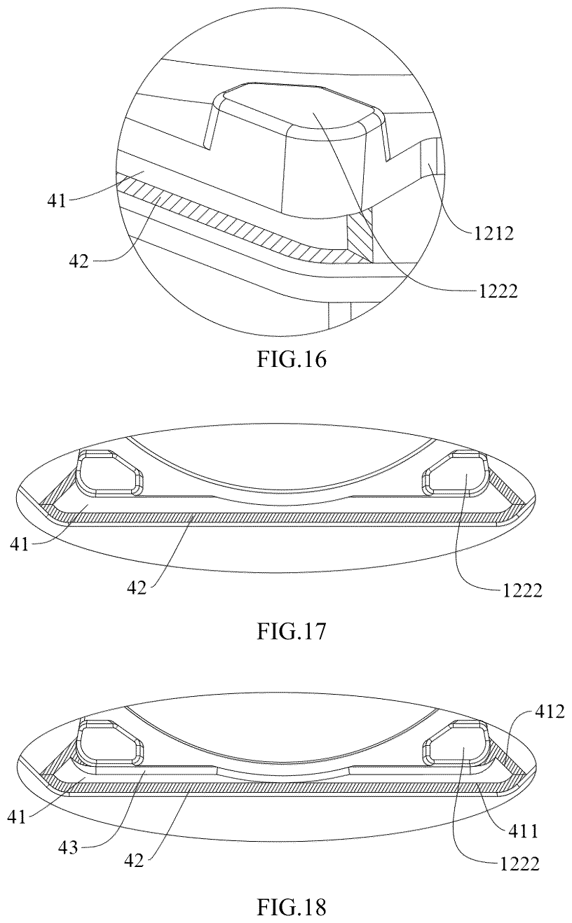

FIG. 16 is a partial schematic view of the main body 11 according to a fifth embodiment of the present disclosure. FIG. 17 is a partial schematic view of the main body 11 according to a sixth embodiment of the present disclosure. FIG. 18 is a partial schematic view of the main body 11 according to a seventh embodiment of the present disclosure.

In some implementations, as shown in FIG. 5, the layout surface 111 is a hexagonal plane. The number of first sides 1111 is two, and they are parallel to each other. The hexagonal plane further comprises two second sides 1112 parallel to each other. The second sides 1112 are perpendicular to the first sides 1111, and a length of the second sides 1112 is greater than a length of the first sides 1111. Referring further to FIGS. 16-18, the fixed protrusion 121 further comprises two second fixed blocks 1212. The two second fixed blocks 1212 respectively correspond to the two second sides 1112. The stopping body 122 further comprises two pairs of second stopping bodies 1222. Each pair of second stopping bodies 1222 is respectively disposed on the two second fixed blocks 1212, and the two second stopping bodies 1222 on the same second fixed block 1212 are spaced apart. One side of the first reinforcement layer 41 is connected to the second fixed block 1212, and another side thereof extends towards the second side 1112.

Optionally, the first stopping bodies 1221 and the second stopping bodies 1222 have the same height. This allows the first stopping bodies 1221 and the second stopping bodies 1222 to simultaneously abut against the limiting structure, thereby ensuring that an axis of the lens 3 consistently coincides with an optical axis. In this embodiment, the reinforcement part 13 is utilized to reinforce both the main body 11 and the stopping part 12 along the length direction of the first sides 1111 and the length direction of the second sides 1112, thereby enhancing the overall strength of the lens mounting base 1.

Furthermore, as shown in FIG. 16, the second reinforcement layer 42 from the aforementioned embodiments may be disposed along an edge of the first reinforcement layer 41 to increase the strength between the second fixed block 1212 and the main body 11.

Furthermore, as shown in FIG. 17, the third reinforcement layer 43 from the aforementioned embodiments may be disposed between the first reinforcement layer 41 and the second fixed block 1212 to further increase the strength between the second fixed block 1212 and the main body 11.

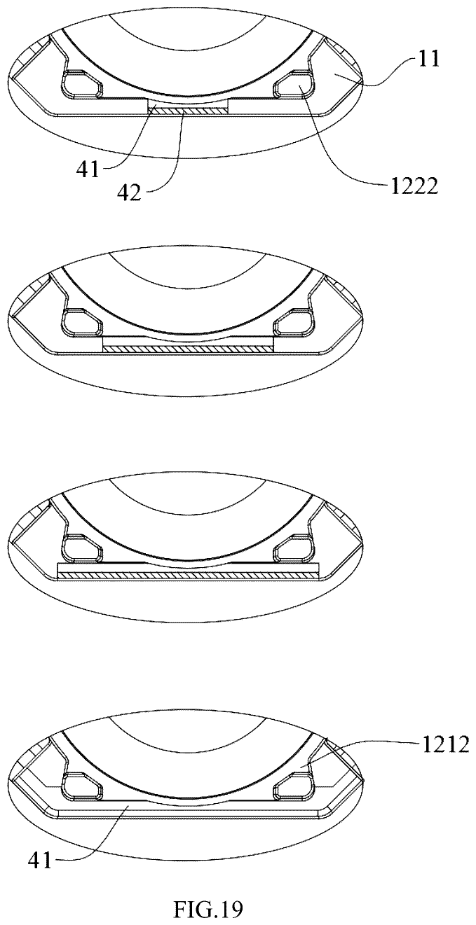

FIG. 19 is a partial schematic view of the main body 11 according to an eighth embodiment of the present disclosure.

In some implementations, as shown in FIG. 19, the length of the first reinforcement layer 41, used for reinforcing the connection between the second fixed block 1212 and the main body 11, may be selected based on the magnitude of the impact force generated by the drive coil 6. For example, the first reinforcement layer 41 may be disposed between two second stopping bodies 1222, with its length configured to be 0.9 mm or 1.8 mm. As another example, two ends of the first reinforcement layer 41 may be disposed on two sides of the second fixed block 1212 and extend along the edge of the layout surface 111. Its length may be configured as 2.7 mm, 3.6 mm, 4.5 mm, or a greater distance.

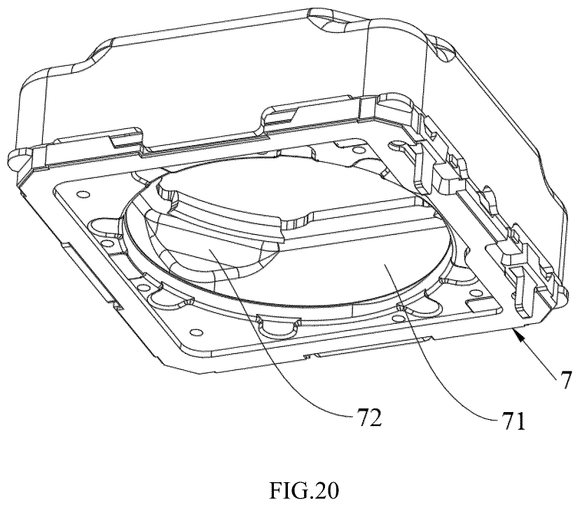

FIG. 20 is a schematic structural view of the housing 7 of the present embodiment.

In an optional implementation, as shown in FIGS. 1-20, the lens assembly from the aforementioned embodiments can be applied to a lens module. The lens module further comprises a housing 7. The housing 7 has a mounting cavity 71, and the mounting cavity 71 has a limiting surface 72. The lens assembly moves towards the limiting surface 72 under the drive of the drive coil 6. When the stopping part 12 abuts against the limiting surface 72, the elastic part 2 elastically deforms, and a reset elastic force is generated. Consequently, when power supply to the drive coil 6 is stopped, the elastic part 2 promptly drives the lens mounting base 1 to reset.

In summary, in the lens module of this embodiment, the elastic part 2 and the lens 3 are disposed on the lens mounting base 1. The first connection area 21 of the elastic part 2 is used for fixed connection with the lens mounting base 1, and the second connection area 22 is used for fixed connection with an inner area of the lens module, thereby suspending the lens mounting base 1 within the lens module. Meanwhile, the stopping part 12 can also be used to restrict the movement distance of the lens 3 within the lens module. Thus, configuring the stopping part 12 to extend out from the hollowed-out area 5 allows the stopping part 12 to avoid the elastic part 2. Simultaneously, disposing the first reinforcement layer 41 between the stopping part 12 and the edge of the layout surface 111 may specifically improve the mechanical strength at the edge position of the main body 11. This prevents damage to the lens mounting base 1 after prolonged use of the lens assembly and prevents the edge position of the main body 11 from warping upward from the layout surface 111. On the other hand, during the upward movement of the lens mounting base 1, the elastic part 2 undergoes bending deformation. For this purpose, configuring the first reinforcement layer 41 to be disposed opposite to the hollowed-out area 5 enables the first reinforcement layer 41 to avoid the elastic part 2, preventing collision between the first reinforcement layer 41 and the elastic part 2.

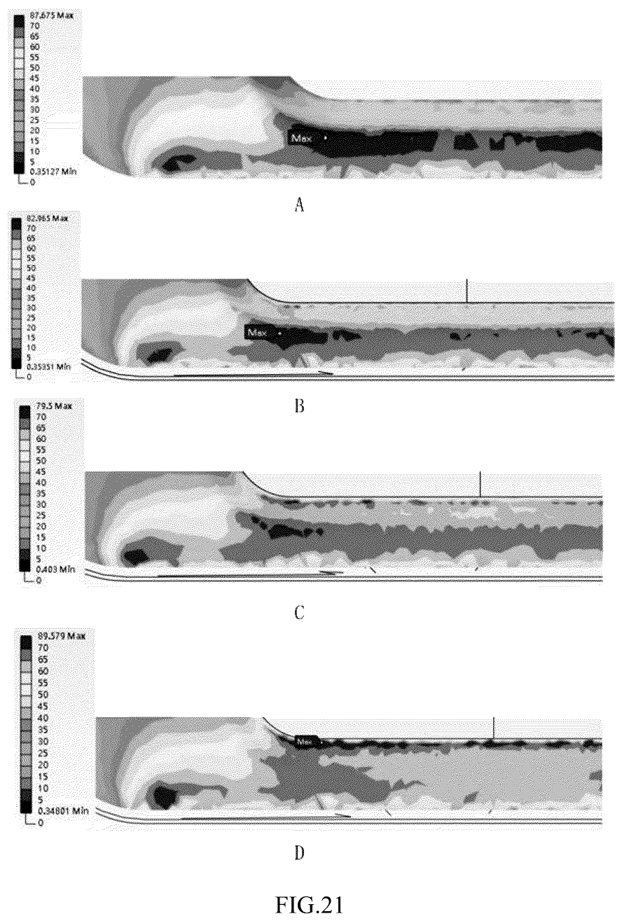

FIG. 21 is a stress simulation diagram of the lens mounting base 1 of the present embodiment. The simulation results show the stress distribution when the first side surface 431 is configured as a flat surface and the stopping part 12 is subjected to an impact force of 25 kg with a duration of 0.08 milliseconds. In the figure, Simulation Result A, Simulation Result B, Simulation Result C, and Simulation Result D correspond to the simulation results when the inclination angle of the first side surface 431 is 25°, 20°, 15°, and 10°, respectively. As can be seen from the figure, the maximum pressures for Simulation Result A, Simulation Result B, Simulation Result C, and Simulation Result D are 87.68 MPa, 82.97 MPa, 79.50 MPa, and 89.58 MPa, respectively.

Therefore, the first side surface 431 may be configured as a flat surface with an inclination angle set to 15°. In this configuration, the third reinforcement layer 43 may provide greater impact resistance and avoid concentration of impact stress at the base of the fixed protrusion 121.

The foregoing descriptions of specific embodiments of the present disclosure have been presented for purposes of illustration and description. They are not intended to be exhaustive or to limit the present disclosure to the precise forms disclosed, and obviously, many modifications and variations are possible in light of the above teaching. The embodiments were chosen and described in order to best explain the principles of the present disclosure and its practical application, thereby enable others skilled in the art to best utilize the present disclosure and various embodiments with various modifications as are suited to the particular use contemplated. It is intended that the scope of the present disclosure be defined by the claims appended hereto and their equivalents.

I/We claim:

1. A lens assembly, wherein the lens assembly comprises:
a lens;
an elastic part, comprising a first connection area and a second connection area, the first connection area and the second connection area being spaced apart to form a hollowed-out area; and
a lens mounting base, comprising a main body, a stopping part, and a reinforcement part, the lens being disposed on the main body, the main body comprising a layout surface perpendicular to an axial direction of the lens, the reinforcement part comprising a first reinforcement layer, the stopping part and the first reinforcement layer protruding from the layout surface, and a portion of the stopping part extending out from the hollowed-out area, the first connection area being fixedly connected to the main body;
wherein the first reinforcement layer extends from the stopping part towards an edge of the layout surface, and a projection of the first reinforcement layer on the elastic part is located inside the hollowed-out area.

2. The lens assembly according to claim 1, wherein the stopping part comprises:
a fixed protrusion, protruding from the layout surface, the first connection area being fixedly connected to a top surface of the fixed protrusion; and
a stopping body, protruding from the top surface of the fixed protrusion and passing through the hollowed-out area, wherein a protrusion height of the reinforcement part is less than or equal to a protrusion height of the fixed protrusion, and the first reinforcement layer is connected to a side wall of the fixed protrusion.

3. The lens assembly according to claim 2, wherein the elastic part further comprises an elastic connection body, the elastic connection body comprises a plurality of first elastic arms, the second connection area is provided in plurality and extends laterally from the lens mounting base, two adjacent second connection areas are connected by a first elastic arm, and at least a portion of the hollowed-out area is formed between the first elastic arm and the first connection area;
wherein the stopping body comprises a plurality of first stopping bodies, the plurality of first stopping bodies corresponding to at least a portion of the first elastic arms;
wherein the first reinforcement layer has a first side edge, the first side edge is located on a side of the first reinforcement layer away from the fixed protrusion, and at least a portion of the first side edge is parallel to and spaced apart from a corresponding first elastic arm.

4. The lens assembly according to claim 3, wherein the layout surface is a polygonal plane, the polygonal plane has a plurality of first sides;
wherein the fixed protrusion comprises a plurality of first fixed blocks, the plurality of first fixed blocks correspond to the plurality of first sides, the first fixed block has a first connection surface and two second connection surfaces facing two sides of the first connection surface, the first connection surface is parallel to a corresponding first side;
wherein the first reinforcement layer further has two second side edges corresponding to the two second connection surfaces, the second side edges extend straight from the second connection surfaces towards an edge of the polygonal plane, ends of the two second side edges away from the first fixed block are spaced apart from each other and are connected to two ends of the first side edge.

5. The lens assembly according to claim 4, wherein the reinforcement part further comprises a second reinforcement layer protruding from the layout surface, the second reinforcement layer comprises a first extension segment, one side of the first extension segment is connected to the second side edge, and another side thereof connects to the layout surface at an incline.

6. The lens assembly according to claim 5, wherein the second reinforcement layer comprises a second extension segment, the second extension segment corresponds to the first elastic arm, one side of the second extension segment is connected to the first side edge, and another side thereof connects to the layout surface at an incline, so as to avoid the first elastic arm.

7. The lens assembly according to claim 5, wherein the elastic connection body further comprises a plurality of second elastic arms corresponding to the plurality of second connection areas, one end of the second elastic arm is connected to a corresponding second connection area, and another end thereof is connected to the first connection area;
wherein the second elastic arm is disposed in the hollowed-out area, and a portion of the second elastic arm is opposite to a portion of the first extension segment.

8. The lens assembly according to claim 7, wherein the main body has a mounting hole, the lens is disposed in the mounting hole;
wherein the first connection area comprises an annular body, an inner edge of the annular body forms an avoidance hole corresponding to the mounting hole, and the lens extends out through the avoidance hole.

9. The lens assembly according to claim 8, wherein the second elastic arm extends curvilinearly and an end thereof is connected to an outer edge of the annular body.

10. The lens assembly according to claim 8, wherein the first connection area further comprises:
a connection piece, extending out from the outer edge of the annular body, wherein the plurality of second elastic arms extend curvilinearly and ends thereof are connected to the connection piece.

11. The lens assembly according to claim 2, wherein the reinforcement part further comprises a third reinforcement layer, at least a portion of the third reinforcement layer is disposed on a top of the first reinforcement layer and extends along the side wall of the fixed protrusion, the third reinforcement layer is opposite to the hollowed-out area.

12. The lens assembly according to claim 11, wherein the third reinforcement layer has a first side surface, one side of the first side surface is connected to the fixed protrusion, and another side thereof is connected to the top of the first reinforcement layer, the first side surface is an arc surface or a flat surface;
wherein a cross-sectional shape of the arc surface in an extending direction is a circular arc, and a radius of the circular arc is 0.06 mm to 0.12 mm;
wherein a side of the flat surface connected to the first reinforcement layer is inclined towards the layout surface, and an inclination angle is 10° to 25°.

13. The lens assembly according to claim 4, wherein the layout surface is a hexagonal plane, the number of first sides is two and they are parallel to each other;
wherein the hexagonal plane further comprises two second sides parallel to each other, the second sides are perpendicular to the first sides, and a length of the second sides is greater than a length of the first sides;
wherein the fixed protrusion further comprises two second fixed blocks, the two second fixed blocks respectively correspond to the two second sides;
wherein the stopping body further comprises two pairs of second stopping bodies, each pair of the second stopping bodies are respectively disposed on the two second fixed blocks, two second stopping bodies on the same second fixed block are spaced apart, one side of the first reinforcement layer is connected to the second fixed block, and another side thereof extends towards the second side.

14. The lens assembly according to claim 1, wherein the lens assembly further comprises a drive coil;
wherein the main body has a coil groove, the coil groove faces a lateral side of the lens mounting base, and an inner wall of the coil groove has a second side surface, the second side surface faces opposite to the layout surface and corresponds to at least a portion of the reinforcement part.

15. The lens assembly according to claim 1, wherein the elastic part further comprises an elastic connection body, the elastic connection body is connected between the first connection area and the second connection area, or the elastic connection body is connected between two second connection areas.

16. The lens assembly according to claim 10, wherein the number of connection pieces is two, and they are arranged symmetrically about the center of the annular body, the number of second elastic arms is four, each single connection piece is connected to two second elastic arms.

17. The lens assembly according to claim 1, wherein the elastic part further comprises an elastic connection body, the elastic connection body comprises a plurality of first elastic arms and a plurality of second elastic arms, the second connection area is provided in plurality and extends laterally from the lens mounting base, two adjacent second connection areas are connected by a first elastic arm, and at least a portion of the hollowed-out area is formed between the first elastic arm and the first connection area;
the second elastic arms correspond to the plurality of second connection areas, one end of the second elastic arm is connected to a corresponding second connection area, and another end thereof is connected to the first connection area.

18. A lens module, wherein the lens module comprises:
a housing, having a mounting cavity, the mounting cavity has a limiting surface; and
the lens assembly according to claim 1, wherein the lens assembly moves towards the limiting surface until the stopping part abuts against the limiting surface, and the elastic part elastically deforms and generates a reset elastic force.

19. The lens module according to claim 18, wherein the elastic part further comprises an elastic connection body, the elastic connection body comprises a plurality of first elastic arms, the second connection area is provided in plurality and extends laterally from the lens mounting base, two adjacent second connection areas are connected by a first elastic arm, and at least a portion of the hollowed-out area is formed between the first elastic arm and the first connection area;
wherein the stopping part comprises:
a fixed protrusion, protruding from the layout surface, the first connection area being fixedly connected to a top surface of the fixed protrusion, the stopping body comprises a plurality of first stopping bodies, the plurality of first stopping bodies corresponding to at least a portion of the first elastic arms; and
a stopping body, protruding from the top surface of the fixed protrusion and passing through the hollowed-out area, wherein a protrusion height of the reinforcement part is less than or equal to a protrusion height of the fixed protrusion, and the first reinforcement layer is connected to a side wall of the fixed protrusion;
wherein the first reinforcement layer has a first side edge, the first side edge is located on a side of the first reinforcement layer away from the fixed protrusion, and at least a portion of the first side edge is parallel to and spaced apart from a corresponding first elastic arm.

20. The lens module according to claim 18, wherein the stopping part comprises:
a fixed protrusion, protruding from the layout surface, the first connection area being fixedly connected to a top surface of the fixed protrusion; and
a stopping body, protruding from the top surface of the fixed protrusion and passing through the hollowed-out area, wherein a protrusion height of the reinforcement part is less than or equal to a protrusion height of the fixed protrusion, and the first reinforcement layer;
wherein the reinforcement part further comprises a third reinforcement layer, at least a portion of the third reinforcement layer is disposed on a top of the first reinforcement layer and extends along the side wall of the fixed protrusion, the third reinforcement layer is opposite to the hollowed-out area.
